(19) United States
(12) Patent Application Publication
(10) Pub. No.: US 2024/0003257 A1
(43) Pub. Date: Jan. 4, 2024

(54) METHOD AND DEVICE FOR MANUFACTURING A DUAL-MATERIAL TURBINE ENGINE DISC AND DISC PRODUCED USING SAID METHOD

(71) Applicant: SAFRAN AIRCRAFT ENGINES, PARIS (FR)

(72) Inventor: Arnaud Cyril LONGUET, MOISSY CRAMAYEL (FR)

(21) Appl. No.: 18/253,510

(22) PCT Filed: Nov. 16, 2021
(86) PCT No.: PCT/FR2021/052022

§ 371 Date: May 18, 2023

(30) Foreign Application Priority Data
Nov. 25, 2020 (FR) FR2012106

(51) Int. Cl. F01D 5/02; F01D 5/34; C23C 4/12; C23C 4/08; C23C 4/18

(52) U.S. Cl. CPC F01D 5/02; F01D 5/34; C23C 4/12; C23C 4/08; C23C 4/18; F05D 2220/32; F05D 2230/30; F05D 2240/30

(57) ABSTRACT

A method for manufacturing a dual-material turbine engine disc, includes the following operations: providing a rough bore made of a first material, mounting the rough bore about an axis of rotation of a rotating device, rotating the rough bore, spraying a second material under solidification conditions, thereby generating a column-like or monocrystalline microstructure, which is different from the first material, on an outer surface of the rough bore in order to produce a dual-material part, and machining the dual-material part to produce a turbine engine disc.

### TECHNICAL FIELD OF THE INVENTION

The present invention relates to a method for manufacturing a dual-material turbomachine disc, the central zone of which is made of a first material and the circumference zone of which is made of a second material. The invention also relates to a manufacturing device implementing this method and a dual-material disc obtained by this method.

The invention finds applications in the field of aeronautics and, especially, in the field of turbomachine compressor or turbine disc manufacture.

### TECHNOLOGICAL BACKGROUND TO THE INVENTION

It is well known in aeronautics that aircraft engines, or turbomachines, are becoming increasingly efficient. As a result, the temperature within some elements of the turbomachines tends to increase. This is especially true of turbine and compressor discs of the turbomachine. As a result of this increasing heat, the discs, which are generally made of equiaxed nickel-based materials, have their properties decreased as the temperatures rise. In particular, they become susceptible to creep, that is they tend to deform irreversibly, which is detrimental to the operation of the turbine or compressor and therefore of the turbomachine.

To limit harmful effects of these high temperatures, it is known to cool hot elements of a turbomachine by means of a cooling air flow. It is known, for example, to cool the discs of a turbine by taking in cooling air from so-called “cold” places in the turbomachine and to inject this cooling air in proximity to the turbine discs to cool them. However, taking in cooling air has the effect of decreasing the efficiency of the turbomachine.

In order to maintain optimum efficiency of the turbomachines, new alloys, more resistant to temperature rise, are being developed and will make it possible to gain a maximum of 100° C. on the maximum operating temperatures.

It has also been contemplated to manufacture the turbomachine discs from a single crystal or directionally solidified material which has the advantage of being more resistant to high temperatures than conventional equiaxed alloys and, in particular, of being resistant to creep. However, such single crystal discs would have anisotropic material properties.

There is therefore a real need for a method that makes it possible to manufacture turbomachine discs that have both good creep resistance and good fatigue resistance, and whose manufacturing technique remains close to known techniques in order to limit the manufacturing cost thereof.

### SUMMARY OF THE INVENTION

In order to address the above discussed problems of the creep and fatigue resistance of turbomachine discs, the applicant provides a method for manufacturing a dual-material turbomachine disc, the central zone of which is made of a first fatigue-resistant material and the circumference zone of which is made of a second creep-resistant material with a columnar or single crystal solidification structure.

According to a first aspect, the invention relates to a method for manufacturing a dual-material turbomachine discs, including the following operations:
providing a rough bore made of a first material,
mounting the rough bore about a rotational axis of a rotating device,
rotating the rough bore,
spraying a second material under solidification conditions generating a columnar or single crystal microstructure, different from the first material, onto an external surface of the rough bore to obtain a dual-material part, and
machining the dual-material part to obtain a turbomachine disc.

This manufacturing method makes it possible to form, around a rough bore made of a conventional material, a circumference zone made of a material with high resistance to high temperatures, the rough bore subjected to a relatively low temperature being resistant to fatigue and the circumference zone subjected to high temperatures being resistant to creep.

In addition to the characteristics just discussed in the preceding paragraph, the method for manufacturing a disc according to an aspect of the invention may have one or more of the following additional characteristics, considered individually or according to any technically possible combinations:
the second material is a nickel-based single crystal material in powder form.
the spraying operation includes laser spraying the single crystal material by making at least one hole in the external surface of the rough bore, inserting a seed of single crystal material therein and melting said seed to orientate the crystal formed.
the second material is a directionally solidified material in powder form.
the rough bore has a circular cross section.
the second material is sprayed by a spraying device in a direction perpendicular to a tangent of the external surface of the rough bore.
a junction between the rough bore and the second material is located in an intermediate zone between a central bore of the disc and a rim of said disc.
after machining the dual-material disc, said disc is subjected to a hot isostatic compression treatment.

Another aspect of the invention relates to a device for manufacturing a dual-material turbomachine disc including a spraying device, fitted with a nozzle for spraying a second material and monitored by a drive device, said manufacturing device being characterised in that it implements the method as defined above.

Advantageously, the spraying nozzle of this device is oriented perpendicular to a tangent of the external surface of the rough bore.

Another aspect of the invention relates to a dual-material turbomachine disc, characterised in that it is obtained by the method as defined above, said disc including a central zone formed of the first material and a circumference zone formed of the second material and in which the grains or crystals of the second material are oriented along a radial direction.

### BRIEF DESCRIPTION OF THE FIGURES

Further advantages and characteristics of the invention will become apparent upon reading the following description, illustrated by the figures in which:

FIG. 1 represents, in the form of a functional diagram, different operations of one embodiment of the manufacturing method according to the invention;

FIG. 2 represents a schematic view of a device for manufacturing a turbomachine disc according to one embodiment of the invention;

FIG. 3 represents a perspective view of an example turbomachine disc made with the method of FIG. 1; and

FIG. 4 represents a perspective view of an example vane disc made with the method of FIG. 1.

### DETAILED DESCRIPTION

An example embodiment of a method and apparatus for manufacturing a turbomachine disc, the central zone and circumference zone of which are made of different materials, is described in detail below, with reference to the attached drawings. This example illustrates the characteristics and advantages of the invention. It is however reminded that the invention is not limited to this example.

In the figures, identical elements are marked by identical references. For reasons of legibility of the figures, the size scales between the elements represented are not respected.

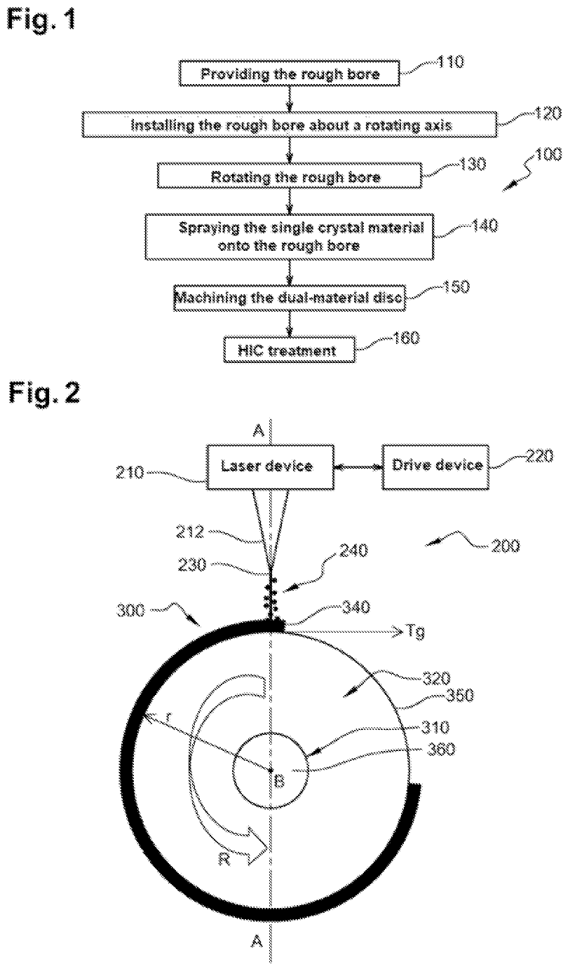

An example embodiment of the method 100 for manufacturing a dual-material turbomachine disc is represented in FIG. 1. This method 100 consists in applying, by means of a spraying device 200, an example of which is represented in FIG. 2, a high creep resistance material 340 onto the circumference 350 of a rough bore 320.

The rough bore 320 is a part, for example with a circular cross-section, made according to a traditional technique, of a metal material or an alloy usually used in the field of turbomachine discs. This material, referred to as the first material, may be for example inco718®, R65®, AD730®, N18®, or any other alloy for forged discs conventionally used in the field of turbomachine disc manufacture. This rough bore 320 may be a new part intended to be transformed into a disc by the method according to the invention; alternatively, this rough bore 320 may be a turbomachine disc whose damaged circumference is reconstructed by applying a creep-resistant material according to the method of the invention.

In the example of FIG. 1, the method 100 includes a step 110 of providing the rough bore and selecting the material to be sprayed onto the circumference of said rough bore 320. This material may be, for example, a nickel-based single crystal material, a ceramic or a directionally solidified material. A single crystal material is a solid material, for example a metal or an alloy, consisting of a single crystal, formed from a single seed, or crystal. A directionally solidified material is a metal or alloy whose crystals expand in a predefined direction during the solidification phase. In the description, the term “second material” will be used to refer either to a single crystal material or to a directionally solidified material, since both materials have improved creep properties compared to the first material of which the rough bore is formed.

According to the invention, the second material is applied layer by layer onto the circumference of the rough bore 320. For this, the rough bore 320 is mounted about an axis of rotation 360 of a rotating device (step 120 of FIG. 1) and rotatably driven (step 130 of FIG. 1) by said rotating device, as represented by arrow R in FIG. 2. The axis of rotation 360 is an axis parallel to the transverse axis passing through the centre of the disc.

While the rough bore 320 is rotating (step 130), a spraying device 200 sprays the second material onto the periphery, or circumference, of said rough bore at a predetermined speed to allow deposition of a layer of a predetermined thickness onto the circumference of said rough bore. This step of spraying 140 the second material 240 is carried out by means of a spraying device 200 such as that represented in FIG. 2. This spraying device 200 can be, for example, a laser device 210, equipped with a nozzle 230 ensuring the spraying of the second material with a selected orientation. The laser device 210 is connected to a drive device 220 which ensures the control and monitoring of the parameters of the laser device 210, such as the speed, flow rate and/or heating temperature of the second material. The laser device 210 may be, for example, the laser device described in patent application FR 2,874,624 or any other laser device adapted to spray a material along a selected direction.

According to some embodiments, the rough bore 320 is driven in a continuous rotational motion, at a predetermined speed and adapted to the flow of the second material coming out of the nozzle 230 of the spraying device. The second material, whether it is single-crystal or directionally solidified, is in the form of a homogeneous powder 240, sprayed in the direction of the circumference of the rough bore 320, in the same axis AA as the laser beam 212. This powder 240 is melted by the laser beam and transforms, upon contact with the heated rough bore 320, into a fluid bead 340. Several thicknesses of the bead 340 may be applied on top of each other and/or next to each other to form a uniform layer on the circumference, or external surface, of the rough bore 320. The bead 340 has a thickness determined as a function of the parameters of the spraying device and the second material; this thickness may, for example, be in the order of 1 mm.

As explained above, the powder 240 of the second material is transformed into a bead 340 upon contact with the rough bore 320. For this, the rough bore 320 is heated by a heating device, not visible in the figures, positioned in the proximity of said rough bore. This heating device may be, for example, a heating plate mounted inside the rough bore or in close proximity to part of the external surface of the rough bore receiving the powder, that is substantially in line with the nozzle 230. The heating device may be associated with one or more heat monitoring devices, such as for example a thermal sensor, a thermal camera, a pyrometer, etc., such that the heating device may be thermally controlled. Thus, in the presence of the heated rough bore, the second material powder 240 transforms into a fluid bead 340 capable of adhering to the circumference zone of said rough bore 320. The circumference zone of the rough bore thus gradually increases in thickness and/or width with each new layer of bead 340.

In some embodiments, the powder 240 is a powder of the selected single crystal material. In these embodiments, a seed (a piece of single crystal material oriented in the desired direction) is placed into a hole, in the external surface of the rough bore, where it is re-melted by the laser upon spraying the single crystal material powder. Although the single crystal material has different mechanical properties depending on the angle, the method allows generation of a curved single crystal, that is with a low local disorientation, which allows the main axis of the single crystal to be oriented along the radius of the disc. The circumference zone 350 of single crystal material is thus a zone with high resistance to high temperatures and, in particular, to creep.

In some other embodiments, the powder 240 is a powder of a directionally solidified material such as, for example, DS200 alloy. In these embodiments, the directionally solidified material is sprayed by the spraying device, for example a laser device, onto the external surface of the rough bore where it transforms into a bead 340. The directionally solidified material is an anisotropic material whose properties are not the same in all directions. However, the properties of this material in an axial/tangential plane (AA-Tg), that is in the direction of the grains of the material and thus the direction of solidification, are relatively close to those of the rough bore. Thus, although the creep resistance properties are less than those of the single crystal material, the creep resistance properties of the directionally solidified material are better than those of a conventionally equiaxed material, and the connection between the rough bore 320 and the circumference zone 350 of the directionally solidified material is greater than that of a single crystal material.

Regardless of the material selected, the powder 240 is sprayed onto the rough bore 320 with a predefined orientation. As represented in FIG. 2, the powder 240 is sprayed along a direction AA, perpendicular to the tangent Tg of the circumference of the rough bore 320. By spraying the second material along this direction AA, each grain or crystal of the material is positioned along a radial direction of the disc. In other words, each grain of the second material is deposited along a radius r of the disc such that the circumference zone 350 of the rough bore becomes a zone with optimum creep properties, with the central zone of the disc retaining the optimum fatigue properties of conventional materials.

The disc 300 manufactured according to the method of the invention thus has a temperature gradient extending from the centre of the disc to the circumference of the disc, the grains or crystals in the circumference zone being disposed in the same direction as this temperature gradient.

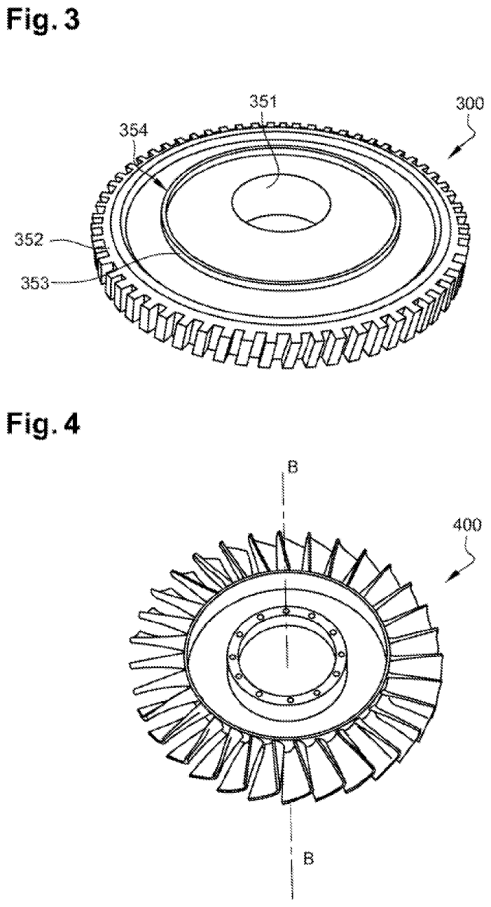

When a dual-material part is obtained according to any of the embodiments of the method previously described, this part can be machined (step 150 of FIG. 1) in order to obtain a turbomachine disc. Indeed, at the end of the step 140 of spraying the second material onto the rough bore, the part obtained is a dual-material part including a central zone made of the first material and a circumference zone made of the second material. This part can then be machined, like any other turbomachine disc, by any known machining technique. The disc obtained can be a disc 300 equipped with a vane attachment system, as represented in FIG. 3, or a one-piece vane disc 400, as represented in FIG. 4. Indeed, if the dimensions of the dual-material part are sufficiently large, the disc as well as the vanes can be machined in the dual-material part such that the vanes, which are the elements most subjected to the high temperatures, are also made of the second material. Such a machining mode allows a gain in mass, not only for the vanes, but also for the disc, since the mass to be carried is less. Furthermore, it makes it possible to dispense with the mechanical connections between the vanes and the disc.

The disc 300, 400 obtained at the end of the machining step 150 may, like any turbomachine disc, undergo a treatment intended to improve or optimise its intrinsic properties. For example, as represented in FIG. 1, the disc 300, 400 may undergo a Hot Isostatic Compression treatment (more simply referred to as HIC treatment) to eliminate any porosities on the surface of the disc and thus optimise the properties of the first and second materials.

As previously explained, the disc obtained with the method according to the invention, such as the disc 300 represented in FIG. 3 or the vane disc 400 represented in FIG. 4, consists of two distinct materials forming several zones of the disc:
a central zone 351, corresponding at least in part to the rough bore, located in the vicinity of the transverse axis BB of the disc and formed of one of the first materials usually used for manufacturing turbomachine discs;
a rim 352 formed by the second material circumference zone; and
a web 354, or intermediate zone, located between the rim 352 and the central zone 251.

It is known in the field of turbomachines that the bore is the part least exposed to high temperatures, in contrast to the rim—and even more so the vanes—which are parts highly exposed to high temperatures. For example, in normal use, the rim can be exposed to a maximum temperature of 750° C. while the vane can be exposed to a maximum temperature of 1,150° C. As the central zone 351 is the least hot part of the disc, it can be formed of a conventional material and thus has good fatigue resistance. On the contrary, the rim 352 being the part of the disc most exposed to high temperatures, it is advantageous that it is made of a second material. The junction 353 between the first material and the second material can, for example, be housed in the web 354, as shown in FIG. 3, since the web 354 is the part of the disc that is the least mechanically stressed. Indeed, since the junction between the two materials is a weak point of the structure, it is preferable to place it into a zone where the loads are low, such as the web for example.

Although described through a number of examples, alternatives and embodiments, the method for manufacturing a dual-material disc according to the invention comprises various alternatives, modifications and improvements which will be obvious to the person skilled in the art, it being understood that these alternatives, modifications and improvements are within the scope of the invention.

1. A method for manufacturing a dual-material turbomachine disc, comprising:
providing a rough bore made of a first material,
installing the rough bore about an axis of rotation of a rotating device,
rotating the rough bore,
spraying a second material under solidification conditions generating a columnar or single crystal microstructure, different from the first material, onto an external surface of the rough bore to obtain a dual-material part, and
machining the dual-material part to obtain a turbomachine disc.

2. The method according to claim 1, wherein the second material is a nickel-based single crystal material in powder form.

3. The method according to claim 2, wherein the spraying operation consists in laser spraying the single crystal material by making at least one hole in the external surface of the rough bore, inserting a seed of single crystal material therein and melting said seed.

4. The method according to claim 1, wherein the second material is a directionally solidified material in powder form.

5. The method according to claim 1, wherein the rough bore has a circular cross-section.

6. The method according to claim 1, wherein the second material is sprayed by a spraying device along a direction perpendicular to a tangent of the external surface of the rough bore.

7. The method according to claim 1, wherein a junction between the rough bore and the second material is located in an intermediate zone between a central zone of the disc and a rim of said disc.

8. The method according to claim 1, wherein, after machining the dual-material disc, said disc is subjected to a hot isostatic compression treatment.

9. A device for manufacturing a dual-material turbomachine disc comprising a spraying device, fitted with a nozzle for spraying the second material and monitored by a drive device, and a heating device configured to heat the rough bore, wherein said manufacturing device is configured to implement the method according to claim 1.

10. The device according to claim 9, wherein the spraying nozzle is oriented perpendicular to a tangent of the external surface of the rough bore.

11. A dual-material turbomachine disc, obtained by the method according to claim 1, said disc including a central zone formed of the first material and a circumference zone formed of the second material and in which grains or crystals of the second material are oriented along a radial direction.
